(19) United States
(12) Patent Application Publication
(10) Pub. No.: US 2026/0286873 A1
(43) Pub. Date: Sep. 24, 2026

(54) APPARATUS FOR LEADING OFF CONDENSED WATER FROM AN EXHAUST TRAIN

(71) Applicants: FRIEDRICH BOYSEN GMBH & CO. KG, Altensteig (DE); BMW AG, München (DE)

(72) Inventors: Christoph Hesselmann, Vogtareuth (DE); Christoph Holzner, Kirchheim (DE); Thomas Mühl, Rott am Inn (DE); Stephan Wenzel, München (DE); Jürgen Kobe, Nürtingen-Raidwangen (DE); Steffen Bader, Bondorf (DE); Martin Siring, Dettenhausen (DE); Volker Roller, Simmersfeld (DE)

(21) Appl. No.: 19/565,825

(22) Filed: Mar. 13, 2026

(30) Foreign Application Priority Data
Mar. 21, 2025 (DE) 102025111042.5

(51) Int. Cl. F01N 3/00; B01D 53/26

(52) U.S. Cl. CPC F01N 3/005; B01D 53/26; B01D 2257/80; B01D 2258/01; B01D 2259/4566

(57) ABSTRACT

An apparatus for leading off condensed water from an exhaust train comprises a housing that is configured for fastening to a line component of the exhaust train, that defines a storage space for condensed water and that has an inlet to be brought into fluid communication with the line component and an outlet leading into the atmosphere. A discharge pipe is arranged at the housing and comprises a first pipe end facing the storage space, a second pipe end forming the outlet and a condensed water channel extending between the first pipe end and the second pipe end.

This application claims the benefit of German Patent Application No. 102025111042.5, filed on Mar. 21, 2025. The entire disclosure of the application referenced above is incorporated herein by reference.

The invention relates to an apparatus for leading off condensed water from an exhaust train, said apparatus comprising a housing that is configured for fastening to a line component of the exhaust train, that defines a storage space for condensed water and that has an inlet to be brought into fluid communication with the line component and an outlet leading into the atmosphere.

During the combustion process in an internal combustion engine, a certain amount of water vapor is accumulated depending on the operating state. It condenses in the exhaust gas system at comparatively cold surfaces and collects as condensed water in certain regions of the exhaust train.

The condensed water can be discharged from the rear region of the exhaust gas system by atomization in the flowing exhaust gas and by a blowing out of the tailpipe. However, this kind of discharge only works during the operation of the internal combustion engine.

Increasingly, significant amounts of condensed water are also formed in the middle region of exhaust trains, in particular in hybrid engines, fuel cell drives and/or during short-distance operation. This poses a problem because the condensed water can slosh around as a result of driving maneuvers such as braking and accelerating and can wet catalytic converter components and/or filter components. Such a wetting or even a soaking impairs the function of the corresponding exhaust gas treatment components and is therefore undesirable. A further problem is that sensors that are sensitive to condensate, and thus should not be wetted either, are installed in modern exhaust gas systems.

A leading off of condensed water can also take place via a lower-side opening in the housing that is filled with a porous material to prevent an excessive gas escape. DE 10 2023 108 927 A1 discloses an apparatus for leading off condensed water in which a porous material is arranged between the inlet and the outlet of the housing. However, corresponding materials are relatively expensive. Furthermore, corrosion products can accumulate at the porous material so that the pores are gradually clogged. A further problem is that it is difficult to prevent an escape of unwanted quantities of exhaust gas components, in particular of carbon dioxide, through the opening. This is in particular problematic due to the increasingly strict approval regulations for exhaust gas systems and motor vehicles.

It is therefore an object of the invention to specify an apparatus that enables an efficient leading off of condensed water with simple means and without a significant influence on the emission values.

The object is satisfied by an apparatus having the features of claim 1.

According to the invention, a discharge pipe is arranged at the housing and comprises a first pipe end facing the storage space, a second pipe end forming the outlet and a condensed water channel extending between the first pipe end and the second pipe end.

Larger accumulations of condensate can also be efficiently led off from the housing via the discharge pipe. However, in an apparatus according to the invention, a continuous leading off of small amounts of water takes place, and indeed both during operation and when the system is at a standstill. It has been shown that if a discharge pipe comprising a condensed water channel is present, no porous materials need to be provided at or in the outlet in order to protect the environment from an unwanted escape of exhaust gas, from an excessive condensate outflow and from an excessive noise emission.

The housing preferably has an upper side and an oppositely disposed lower side, with the discharge pipe being arranged at the lower side of the housing. The arrangement of the discharge pipe at the lower region of the housing promotes a leading off of water by means of gravity.

It is preferred that the second pipe end is arranged further down than the first pipe end with respect to a downward direction pointing from the upper side to the lower side in order to enable an independent flowing of condensate out of the storage space to the outside.

According to one embodiment of the invention, the condensed water channel extends obliquely to the downward direction. This means that the discharge pipe is oriented similarly to a tailpipe so that the exhaust gases escaping from the condensed water channel are conducted away from the vehicle without acoustic disadvantages. If required by the approval regulations, the discharge pipe can be declared as an additional tailpipe.

One embodiment of the invention provides that the housing comprises a tub-like base part having a tub bottom, side walls and a tub opening, with the discharge pipe being arranged in the region of the tub bottom. To facilitate a covering of the tub-like base part with another part, an edge can extend along the tub opening, for example, can extend around it. Such a base part is comparatively easy to manufacture, for example by deep drawing.

Preferably, the discharge pipe is arranged at an edge region of the tub bottom. This enables a particularly effective leading off of condensed water that collects at the edge region due to inertia, for example when accelerating or braking the associated motor vehicle.

The housing can comprise a hood-like cover part for covering the tub-like base part while enclosing the line component. A hood-like cover part is just as easy to manufacture as a tub-like base part so that a particularly simple design results overall. The hood-like cover part can likewise have an edge that is welded to the edge of the tub-like base part.

According to a further embodiment of the invention, the condensed water channel has a maximum diameter of at least 0.1 mm and at most 5 mm, preferably of at least 0.5 mm and at most 2 mm. In such a design, the condensed water channel is wide enough to ensure an effective discharge, on the one hand, but narrow enough to avoid an unwanted puddle formation, an excessive escape of exhaust gas from the housing and acoustic disadvantages, on the other hand.

According to a further embodiment of the invention, the condensed water channel has a length of at least 5 mm and at most 70 mm, preferably of at least 10 mm and at most 40 mm, and particularly preferably of approximately 25 mm. Such lengths, in particular in combination with a channel width as described above, have proven to be particularly advantageous with respect to the desired discharge and outflow limitation. The condensed water channel can widen, starting from a central channel section and/or a constriction, towards the first pipe end and/or towards the second pipe end. The condensed water channel can in particular be shaped like a Venturi tube. A suction effect thereby results that promotes the condensate discharge. In particular, a clogging of the condensed water channel due to the surface tension of the condensed water is thereby counteracted.

The condensed water channel preferably has an at least substantially rectilinear extent. This simplifies the production and avoids unwanted drainage obstacles.

The condensed water channel is preferably free of flow-limiting components and materials in order not to unnecessarily impede the outflow from the storage space and furthermore to save costs.

According to a further embodiment of the invention, the discharge pipe is welded, screwed or clamped to a wall of the housing. The discharge pipe can be provided with an end-side flange for this purpose. This results in a particularly simple design.

The discharge pipe can be provided in the region of the second pipe end with a device for fastening a closure element that closes the condensed water channel. Thus, in certain situations, for example for emission measurements, an escape of exhaust gases from the housing can be completely prevented. For example, falsifications of approval measurements can be avoided in this way.

According to a specific embodiment of the invention, the device for fastening the closure element comprises an end-side thickening of the discharge pipe. An elastic sealing cap, for example composed of silicone, can be pulled over such a thickening, for example a funnel-shaped thickening, and can be secured with a clip if required. A further embodiment of the invention provides that the device for fastening the closure element comprises a thread. For example, a dummy plug with a matching mating thread can be screwed into the thread.

The invention also relates to an exhaust gas system, in particular for a motor vehicle, comprising at least one line component for guiding an exhaust gas flow along a direction of flow and an apparatus for leading off condensed water as described above, wherein the housing of the apparatus for leading off condensed water is fastened to the line component and an opening is provided in the line component, said opening providing a fluid connection to the inlet of the housing.

Condensed water located in the line component moves through the opening and the inlet into the storage space of the housing and, from there, through the discharge pipe into the atmosphere. The opening can, for example, be a hole, a slot or an arrangement of a plurality of holes and/or slots.

Preferably, the condensed water channel extends obliquely to the direction of flow like a tailpipe.

The discharge pipe can be arranged at a downstream end region of the housing. This optimizes the discharge during the journey.

According to a specific embodiment of the invention, the line component has a recess, with the opening being arranged at an upstream end region of the recess. This enables an efficient collection of condensed water waves that move against the direction of travel during braking phases of the motor vehicle. A design in which an opening or an arrangement of openings is provided exclusively in the upstream end region is particularly favorable. According to a specific embodiment, exactly one opening is provided in the line component and provides a fluid connection to the inlet of the housing.

According to a further embodiment of the invention, the line component has a narrowing of the flow cross-section, said narrowing being arranged upstream of the opening and preferably extending up to the opening. This has proved to be particularly favorable with respect to the collection of condensed water.

Further developments of the invention can also be seen from the dependent claims, from the following description, and from the enclosed drawings.

The invention will be described in the following by way of example with reference to the drawings.

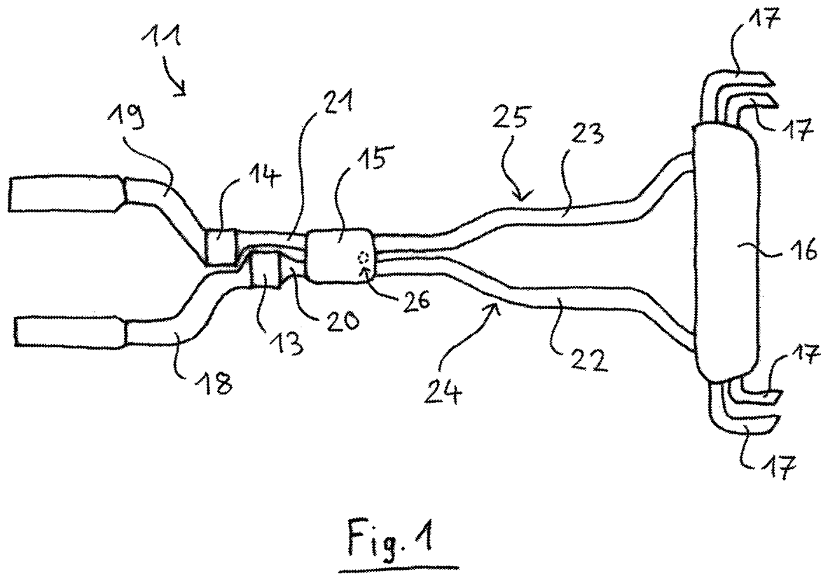

FIG. 1 shows, in simplified form, an exhaust train according to the invention with an apparatus according to the invention for leading off condensed water from the exhaust train in a view from below;

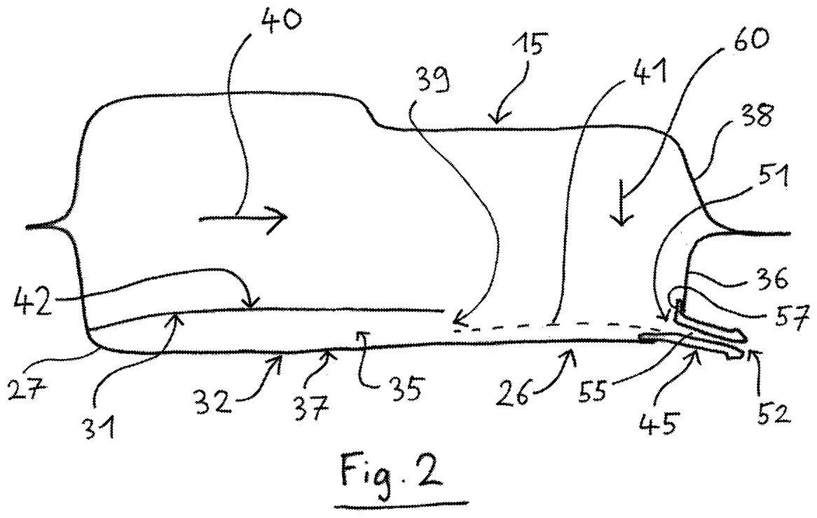

FIG. 2 shows, in a lateral sectional representation, a first embodiment of an apparatus according to the invention for leading off condensed water from an exhaust train;

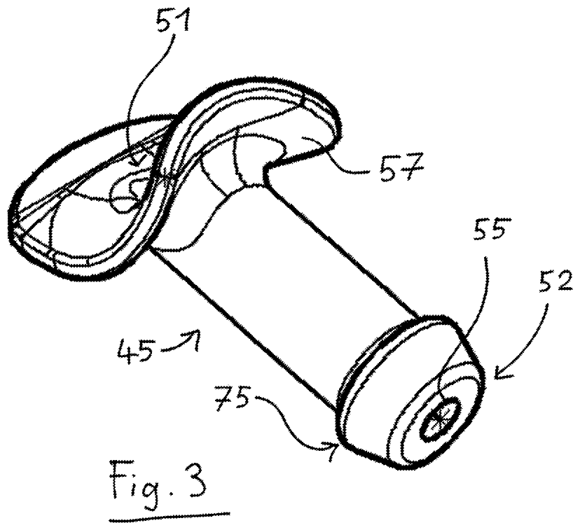

FIG. 3 shows a discharge pipe of the apparatus in accordance with FIG. 2 in a perspective view;

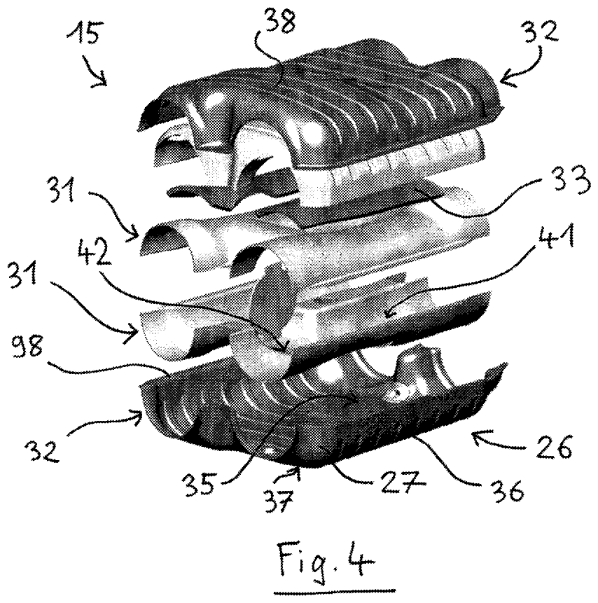

FIG. 4 shows the apparatus in accordance with FIG. 2 in an exploded representation;

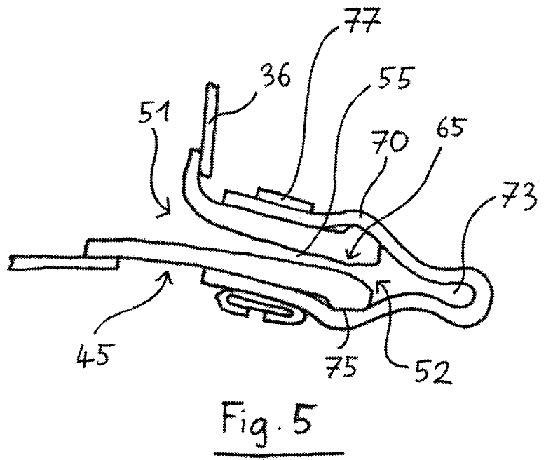

FIG. 5 is a sectional representation of a discharge pipe of the apparatus in accordance with FIG. 2 in a closed state;

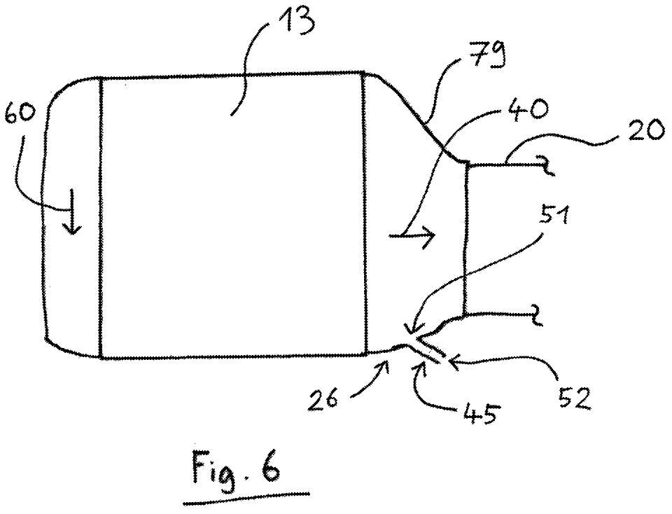

FIG. 6 shows, in a side view, a second embodiment of an apparatus according to the invention for leading off condensed water from an exhaust train; and

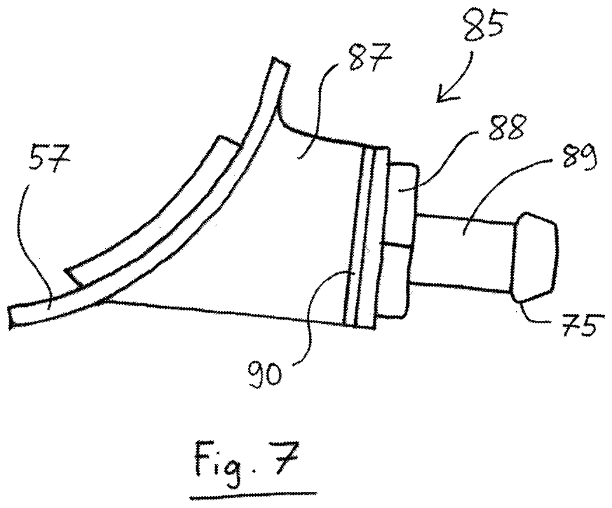

FIG. 7 shows, in a side view, an alternatively designed discharge pipe of an apparatus according to the invention for leading off condensed water from an exhaust train.

The exhaust train 11 shown in FIG. 1 is associated with an internal combustion engine of a motor vehicle and comprises, in a generally known manner, an arrangement of line components for conducting exhaust gas, in particular two catalytic converters 13, 14, a middle muffler 16, a rear muffler 16 with tailpipes 17, and a plurality of pipe pieces 18, 19, 20, 21, 22, 23. Particle filters could be provided as an alternative or in addition to the catalytic converters 13, 14. The individual assemblies of the exhaust train 11 are preferably fastened to the motor vehicle floor (not shown). In the embodiment example shown, the exhaust train 11 comprises two separate paths 24, 25, wherein this is not absolutely necessary, however. Like the rear muffler 16, the middle muffler 15 is jointly provided for both paths 24, 25. It is understood that the exhaust train 11 can, however, have further line components depending on the application.

In particular during short-distance operation and/or when the internal combustion engine is electrically assisted, a formation of condensed water in the middle and rear regions of the exhaust train 11 takes place. The condensed water inter alia collects in the region of the middle muffler 15. So that this accumulation of water does not slosh around, an apparatus 26 for leading off condensed water is integrated into the middle muffler 15.

As can be recognized in FIG. 4, the middle muffler 15 comprises an inner shell 31 and an outer shell 32. The inner shell 31 forms a line component of the exhaust train 11, while the outer shell 32 forms a housing 27 of the apparatus 26 for leading off condensed water. The inner shell 31 is welded to the outer shell 32 in the inlet region and in the outlet region. In the upper half of the middle muffler 15, a sound-absorbing damping material 33 is inserted between the inner shell 31 and the outer shell 32. However, in the lower half of the middle muffler 15, the space between the inner shell 31 and the outer shell 32 is free of damping material so that a collection chamber 35 or a storage space 34 is formed for collected condensate.

In the embodiment example shown in FIGS. 2 and 4, the outer shell 32 and the inner shell 31 are designed in two parts. A tub-like base part 36 of the outer shell 32 comprises a tub bottom 37 and is covered by a hood-like cover part 38. The base part 36 and the cover part 38 enclose the inner shell 31 and, via the latter, the pipe pieces 20, 21, 22, 23 connected to the middle muffler 15. In this respect, an edge 98 serves to place the tub-shaped base part 36 against the lower part of the inner shell 31. The tub-like base part 36 and the hood-like cover part 38 are welded together via the edge 98. Preferably, all the components of the inner shell 31 and the outer shell 32 are made of a heat-resistant material such as sheet metal.

So that the condensate can enter the storage space 35, an opening 39, which can be seen in FIG. 2, is provided in the lower region of the inner shell 31 and provides a fluid connection to the space between the inner shell 31 and the outer shell 32. In the embodiment example shown, the opening 39 is designed as a slot that extends transversely to the direction of flow 40 and that is arranged at an upstream end region of a recess 41 formed at the inner shell 31. Upstream of the recess 41, the inner shell 31 has a narrowing 42 of the flow cross-section, said narrowing extending up to the opening 39. If required, a plurality of slots or differently shaped openings could also be provided in the inner shell 31.

For a fluid communication between the storage space 35 and the atmosphere, a discharge pipe 45 is arranged at the outer shell 32 and comprises a first pipe end 51 facing the storage space 35, a second pipe end 52 leading into the open air and a condensed water channel 55 extending between the first pipe end 51 and the second pipe end 52. In the embodiment example shown, the discharge pipe 45 is arranged at an end region of the outer shell 32 that is downstream with respect to the direction of flow 40. For example, the discharge pipe 45 can be welded to the outer shell 32 of the middle muffler 15, either from the outside or from the inside depending on the design. For this purpose, the discharge pipe 45 shown is provided with a pipe flange 57 at the first pipe end 51, as can in particular be seen in the individual representation in accordance with FIG. 3. Alternatively, the discharge pipe 45 could be screwed or clamped to the outer shell 32 of the middle muffler 15.

The condensed water channel 55 extends at least substantially in a straight line and, similarly to a tailpipe, extends obliquely downwards and rearwards. This means that the condensed water channel 55 extends obliquely to the direction of flow 40 and obliquely to a downward direction 60 that points from the hood-shaped cover part 38 to the tub bottom 37 of the tub-shaped base part 36. The second pipe end 52 is arranged further down than the first pipe end 51 with respect to the downward direction 60.

It is preferred that the condensed water channel 55 has a maximum diameter of at least 0.1 mm and at most 5 mm and has a length of at least 5 mm and at most 70 mm. As can in particular be seen in FIG. 5, the shape of the condensed water channel 55 in a longitudinal section is Venturi-nozzle-like, i.e. the condensed water channel 55 has a constriction 65 and widens, starting from the constriction 65, towards the first pipe end 51 and towards the second pipe end 52.

With respect to the transport of condensed water, an inlet of the housing 27 is formed by the opening 39 (FIG. 2), while the second pipe end 52 forms an outlet of the housing 27.

During the operation of the exhaust train 11, condensed water collects in the recess 41 of the inner shell 31. Said condensed water enters the storage space 35 through the opening 39, wherein the arrangement of the opening 39 assists a collection of the condensed water when braking the motor vehicle because a shaft then moves against the direction of flow 40, i.e. in the direction of travel. From the storage space 35, the condensed water then moves to the discharge pipe 45 and through the condensed water channel 55 to the outside.

The comparatively long and narrow design of the condensed water channel 55 counteracts an exhaust gas leakage and increased noise emissions. Furthermore, due to the throttling, the escape of water from the second pipe end 52 takes place continuously rather than in a gushing manner. It is therefore not necessary to arrange flow-limiting components or materials such as porous plugs in the condensed water channel 55. An intermediate storage of water is made possible by the storage space 35 acting as a collection chamber. Tests have shown that, with an apparatus 26 of the kind described, an amount of over one liter of water can be led off distributed over a period of 7 days.

It is desirable to be able to close the second pipe end 52, for example for comparative measurements. This can take place in a simple way as shown in FIG. 5 by pulling a silicone cap 70 over the second pipe end 52. In this case, the condensed water collects in a reservoir 73 formed by the silicone cap 70. For an improved hold of the silicone cap 70, the discharge pipe 45 is provided with an end-side thickening 75. The silicone cap 70 can be fixedly clamped to the discharge pipe 45 by means of a clamp 77. Instead of the silicone cap 70, an alternative closure element could also be provided, for example, a threaded blind plug that can be screwed into an internal thread (not shown) formed at the condensed water channel 55.

It is not absolutely necessary that the apparatus 26 according to the invention is integrated into a middle muffler 15. The discharge pipe 45 could also be attached to a catalytic converter shell 79, for example in the form of an exit funnel, as shown in FIG. 6. Furthermore, the housing 27 could be adapted for a subsequent attachment to one of the pipe sections 18, 19, 20, 21, 22, 23 in order to enable retrofitting.

An alternatively designed discharge pipe 85 for an apparatus 26 according to the invention for leading off condensed water is shown in FIG. 7. The discharge pipe 85 designed in accordance with FIG. 7 has a nozzle 87 at which the pipe flange 57 is formed. An insertion piece 89 of the discharge pipe 85, said insertion piece being provided with a hexagonal feature 88 and having the thickening 75, is screwed into the nozzle 87 with the interposition of a ring seal 90. If necessary, the insertion piece 89 can be replaced, for example, with another insertion piece 89 or with a dummy plug.

Due to the invention, it is possible to conduct condensed water out of an exhaust gas system independent of the operation, in particular from the middle region of the system that is normally not accessible for a leading out of water by means of atomization.

### REFERENCE NUMERAL LIST

11 exhaust train
13 catalytic converter
14 catalytic converter
15 middle muffler
16 rear muffler
17 tailpipe
18 pipe piece
19 pipe piece
20 pipe piece
21 pipe piece
22 pipe piece
23 pipe piece
24 path
25 path
26 apparatus for leading off condensed water
27 housing
31 inner shell
32 outer shell
33 damping material
35 storage space
36 tub-like base part
37 tub bottom
38 hood-like cover part
39 opening
40 direction of flow
41 recess
42 narrowing
45 discharge pipe
51 first pipe end
52 second pipe end
55 condensed water channel
57 pipe flange
60 downward direction
65 constriction
70 silicone cap
73 reservoir
75 thickening
77 clamp
79 catalytic converter shell
85 discharge pipe
87 nozzle
88 hexagonal feature
89 insertion piece
90 ring seal
98 edge

1. An apparatus for leading off condensed water from an exhaust train, said apparatus comprising
a housing that is configured for fastening to a line component of the exhaust train, that defines a storage space for condensed water and that has an inlet to be brought into fluid communication with the line component and an outlet leading into the atmosphere,
wherein a discharge pipe is arranged at the housing and comprises a first pipe end facing the storage space, a second pipe end forming the outlet and a condensed water channel extending between the first pipe end and the second pipe end.

2. The apparatus according to claim 1,
wherein the housing has an upper side and an oppositely disposed lower side, with the discharge pipe being arranged at the lower side of the housing.

3. The apparatus according to claim 2,
wherein the second pipe end is arranged further down than the first pipe end with respect to a downward direction pointing from the upper side to the lower side.

4. The apparatus according to claim 3,
wherein the condensed water channel extends obliquely to the downward direction.

5. The apparatus according to claim 1,
wherein the housing comprises a tub-like base part having a tub bottom, side walls and a tub opening, with the discharge pipe being arranged in the region of the tub bottom.

6. The apparatus according to claim 5,
wherein the discharge pipe is arranged at an edge region of the tub bottom.

7. The apparatus according to claim 5,
wherein the housing comprises a hood-like cover part for covering the tub-like base part while enclosing the line component.

8. The apparatus according to claim 1,
wherein the condensed water channel has a maximum diameter of at least 0.1 mm and at most 5 mm.

9. The apparatus according to claim 1,
wherein the condensed water channel has a length of at least 5 mm and at most 70 mm.

10. The apparatus according to claim 1,
wherein the condensed water channel widens, starting from a central channel section and/or a constriction, towards the first pipe end and/or towards the second pipe end.

11. The apparatus according to claim 1,
wherein the condensed water channel has an at least substantially rectilinear extent.

12. The apparatus according to claim 1,
wherein the condensed water channel is free of flow-limiting components and materials.

13. The apparatus according to claim 1,
wherein the discharge pipe is welded, screwed or clamped to a wall of the housing.

14. The apparatus according to claim 1,
wherein the discharge pipe is provided in the region of the second pipe end with a device for fastening a closure element that closes the condensed water channel.

15. The apparatus according to claim 14,
wherein the device for fastening the closure element comprises an end-side thickening of the discharge pipe.

16. The apparatus according to claim 14,
wherein the device for fastening the closure element comprises a thread.

17. An exhaust gas system, comprising at least one line component for guiding an exhaust gas flow along a direction of flow and an apparatus for leading off condensed water according to claim 1, wherein the housing of the apparatus for leading off condensed water is fastened to the line component and an opening is provided in the line component, said opening providing a fluid connection to the inlet of the housing.

18. The exhaust gas system according to claim 17,
wherein the condensed water channel extends obliquely to the direction of flow.

19. The exhaust gas system according to claim 17,
wherein the discharge pipe is arranged at a downstream end region of the housing.

20. The exhaust gas system according to claim 17,
wherein the line component has a recess, with the opening being arranged at an upstream end region of the recess.

21. The exhaust gas system according to claim 20,
wherein the line component has a narrowing of the flow cross-section, said narrowing being arranged upstream of the opening.
